(19) United States
(12) Patent Application Publication
(10) Pub. No.: US 2010/0295900 A1
(43) Pub. Date: Nov. 25, 2010

(54) MINI-EXTRUSION MULTILAYERING TECHNIQUE FOR THE FABRICATION OF CERAMIC/PLASTIC CAPACITORS WITH COMPOSITION-MODIFIED BARIUM TITANATE POWDERS

(75) Inventor: Richard D. Weir, Cedar Park, TX (US)

Correspondence Address: LARSON NEWMAN & ABEL, LLP, 5914 WEST COURTYARD DRIVE, SUITE 200, AUSTIN, TX, 78730, US

(73) Assignee: EESTOR, INC., Cedar Park, TX (US)

(21) Appl. No.: 12/785,266

(22) Filed: May 21, 2010

Related U.S. Application Data
(60) Provisional application No. 61/180,309, filed on May 21, 2009.

(51) Int. Cl. B41J 2/14; B05D 5/12; C08K 3/22; C08L 33/08; C08L 25/06; C08G 75/20; C08L 67/02; C08G 69/38; C08G 18/32

(52) U.S. Cl. 347/47; 427/126.3; 524/413; 524/586; 524/560; 524/577; 524/609; 524/601; 524/606; 524/590

(57) ABSTRACT

A printer includes a work surface and a print head disposed over the work surface. The print head and the work surface are relatively movable in associated planes. The print head includes a first nozzle to deposit a polymeric ink, a second nozzle to deposit a conductive ink, and a third nozzle to deposit a dielectric ink.

### CROSS-REFERENCE TO RELATED APPLICATION(S)

The present application claims priority from U.S. Provisional Patent Application No. 61/180,309, filed May 21, 2009, entitled “MINI-EXTRUSION MULTILAYERING TECHNIQUE FOR THE FABRICATION OF CERAMIC/PLASTIC CAPACITORS WITH COMPOSITION-MODIFIED BARIUM TITANATE POWDERS,” naming inventor Richard D. Weir, which application is incorporated by reference herein in its entirety.

### BACKGROUND

Capacitors have long been used to build circuits. In particular, capacitors have been used in energy circuits to decouple DC voltage from AC current. In other examples, capacitors have been used in electronic circuits to provide desired circuit responses and functions. More recently, large capacitors have been proposed as energy storage devices.

Previously, single-layer capacitors, including electrodes located on ether side of a single dielectric layer, have been formed through screen-printing processes. Such processes generally include printing a layer through a mask and baking the layer prior to adding a second layer. While such processes may be acceptable for single-layer capacitors, screen printing is inefficient for multiple-layer capacitors.

To form a multiple-layer capacitor, screen-printing techniques would lead to a large number of repetitive baking steps, each involving heating, treatment, and cooling periods that add time and expense to the production process. As such, screen-printing techniques have proven less desirable for forming multilayer capacitors and in particular, capacitive storage devices.

### BRIEF DESCRIPTION OF DRAWINGS

The present disclosure may be better understood, and its numerous features and advantages made apparent to those skilled in the art by referencing the accompanying drawings.

FIG. 1 includes an illustration of an exemplary continuous printing device.

FIG. 2 includes a flow diagram illustrating an exemplary method of forming a capacitive storage device.

FIG. 3, FIG. 4, and FIG. 5 include illustrations of exemplary layers of a capacitive storage device.

FIG. 6 includes an illustration of an exemplary nozzle configuration.

FIG. 7 includes an illustration of an exemplary deposition pattern.

FIG. 8 includes an illustration of a cross-section of an exemplary layered construction.

FIG. 9 includes an illustration of an exemplary deposition pattern.

FIG. 10 and FIG. 11 include illustrations of exemplary nozzles.

The use of the same reference symbols in different drawings indicates similar or identical items.

### DETAILED DESCRIPTION

In a particular embodiment, a set of inks are deposited in patterned layers to form a component of a capacitive energy storage device. An exemplary ink includes conductive particulate and can be used to form electrode. Another exemplary ink includes dielectric ceramic particulate and a polymer powder and can be used to form dielectric layers. A further exemplary ink includes a polymer powder and can be deposited around electrodes and dielectric layers within patterned layers. In a further embodiment, the inks can each be deposited from a print head in continuous streams to form elements of the component.

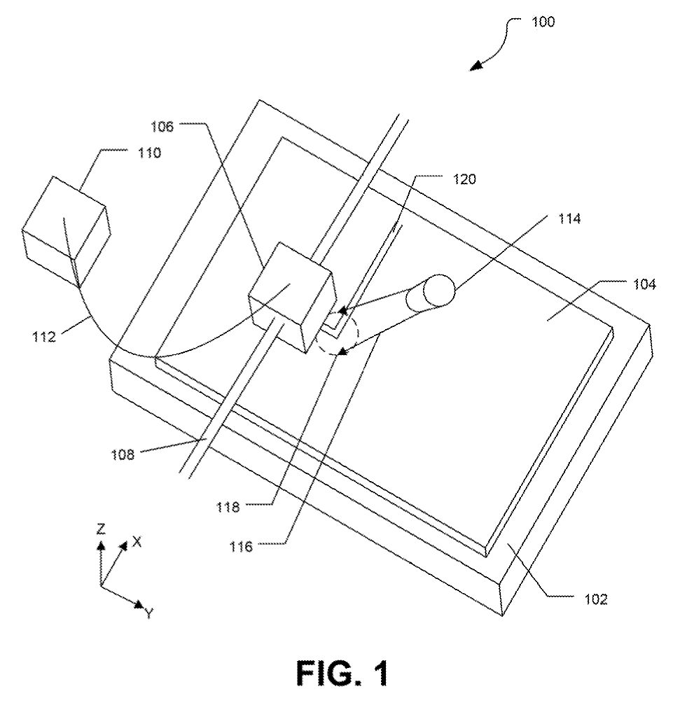

In an exemplary embodiment, a continuous printing apparatus, such as laminar-flow printing device, can be used to form layers of a capacitive storage device. For example, FIG. 1 includes an illustration of an exemplary printing apparatus 100. A work piece support 102 supports and retains a work piece 104. The work piece 104 can be a portion of a multilayer capacitor or can be a poly(ethylene terephthalate) (PET) film or a paper support on which a multilayer capacitor work piece can be initiated. The work piece 104 can be held in place by clamps or pins, by an adhesive film, by vacuum, electrostatically, or any combination thereof. Alternatively, the work piece support 102 can be coated with polytetrafluoroethylene (PTFE) plastic, and a first layer of polymer, such as poly(ethylene terephthalate) (PET), can be printed directly upon the work piece support 102.

In addition, the printing apparatus 100 includes a print head assembly 106 and a print head support 108. In general, the print head assembly 106 is configured to deliver an ink or suspension from a nozzle to the work piece 104 in a continuous flow, such as a laminar flow. In contrast to other printing techniques, ink is delivered in a continuous stream instead of periodic or discrete dots or extrusion through a masked screen. In an example, the print head assembly 106 can be configured to deliver a single stream of ink or of a suspension. In another example, the print head assembly 106 can be configured to deliver the ink or suspension in two or more continuous streams, such as at least two, at least three, at least four, or at least eight streams. For example, the print head assembly 106 can include one or more nozzles, each controllable to deliver ink in continuous streams, such as laminar streams.

In a further embodiment, the print head assembly 106 can be configured to deliver a single ink or suspension. Alternatively, the print head assembly 106 can be configured to selectively deliver two or more inks or suspensions. For example, two or more feed lines can provide two or more ink compositions to the print head assembly 106, and the print head assembly 106 can be configured to selectively or controllably deliver one or more of the ink compositions to the work piece 104. In an example, the print head assembly 106 can be configured to deliver streams of two or more inks simultaneously while in relative motion in relation to the work piece 104.

In an example, the printing apparatus 100 can include one or more containers 110 that are fluidly coupled to the print head assembly 106 via a feed line or feed lines 112. The feed lines 112 provide one or more inks or suspensions from the container 110 to the print head assembly 106. In an embodiment, more than one feed line 112, more than one container 110, or any combination thereof can be connected to the print head assembly 106. Ultrasonic agitation of the ink can be provided to the ink in the container 110 or at a reservoir close to the nozzle of the printing process to assure complete dispersion of the particulate components.

A reservoir associated with inks to be dispensed for forming polymeric layers can be kept at a pressure of 20 psi to 100 psi and a temperature in a range of 20° C. to a 50° C. For the larger or thicker polymeric layers, the reservoir pressure can be held at 20 psi to 100 psi.

For reservoirs associated with the dispensing of dielectric powders or layers, the reservoir can be held at a pressure of 20 psi to 100 psi at a temperature of 20° C. to 50° C. A reservoir associated with nozzles for printing conductive layers can be held at a pressure of 10 psi to 70 psi and a reservoir temperature of 20° C. to 50° C.

Optionally, the printing apparatus 100 can include at least one energy source 114. For example, the energy source 114 can be a radiative source, such as an ultraviolet source, a visible light source, an infrared source, or a combination thereof. In particular, the radiative source can be an infrared heat source, such as a source of electromagnetic energy in the frequency range of between about 1.2×10″ Hz and 1.5×10¹³ Hz. In a further example, the energy source 114 can be in the form of a reflected diffuse light or can be a laser source. In an example, the energy source 114 directs energy 116, such as infrared radiation, to impinge upon at least a portion 118 of the work piece 104 in proximity to the ink dispensed from the print head assembly 106. In an example, the energy source 114 can move with the print head assembly 106 or the direction of the energy 116 can be adjusted to follow the movement of the print head assembly 106 or work piece 104.

In particular, the work piece support 102 or the print head assembly 106, or both are configured to create motion relative to each other, effectively altering the position at which a continuous stream is deposited on to the work piece 104. As a result, a continuous layer 120 is printed on the work piece 104. Depending on the relative motion of the print head assembly 106 and the work piece 104, the layer 120 can be straight, curved, or include sharp angles. In a particular example, the work piece support 102 can be configured to move in one or more of an x- or y-direction relative to a planar surface formed by the work piece support 102. In another example, the print head assembly 106 can be configured to move in one or more of an x- or y-direction. In a further example, the work piece support 102 can be configured to move in a first direction, such as an x-direction or a y-direction, and the print head assembly 106 can be configured to move in a second direction, such as a y-direction or an x-direction. One or both of the work piece support 102 or the print head assembly 106 can be configured to move in the z-direction.

In a particular example, the print head assembly 106 is connected to an upper stationary stainless steel platen of the printing system 100. More than one print head 106 can be coupled to the upper platen. The support 102 moves relative to the print head or heads 106. The number of print head assemblies can be set to provide the product throughput desired since each print head assembly prints layers for individual capacitors simultaneously with the other print head assemblies. However, printing-system size is a factor, so the number of layering print head assemblies can be limited by a practical printing-system size as related to manufacturing space limitations. The printing-system lower plate or support 102 is controlled by the printing-system's xyz sled so that the nozzles can be in the proper location, have the proper height between the nozzle and the lower plate, and traverse at the proper speeds during the layering printing process. The platens are coated with a Teflon® fluorocarbon resin or any suitable mold-release film or a thin layer of Mylar®, poly(ethylene terephthalate) film adhered to the platen surface. The controller of the printing unit ensures that the processing tanks are at the specified temperature and pressure and process parameters as indicated above are completed as specified during the layering process. At the beginning of the printing process the printing unit automatically transports the coated or PET layered stainless steel platen into the unit and locks it into the proper printing location. At the end of the printing process, the printing unit automatically transports the stainless steel platen with the layered capacitor components out of the unit onto a transporting unit so that the components can be processed through the next stage of manufacturing. Layered thicknesses, lengths, and widths that are controlled by the extruder slits and the other processing parameters can be varied to meet the specifications of the particular application.

Exemplary parameter-setting capabilities and process setting for such parameters can be utilized to achieve successful extruding of the layer thicknesses indicated. For example, desired layer thickness can be controlled by varying the reservoir temperatures, varying the viscosity of the inks, adjusting the extruder silt widths, setting the pressure in the processing tanks, setting the height of the nozzle from the deposition platen surface, setting the speed of the nozzle in relationship to the deposition platen, setting the width of the nozzle slit and length of the layering process to establish the size of the capacitors, varying the layer curing temperature and air velocity, or any combination thereof.

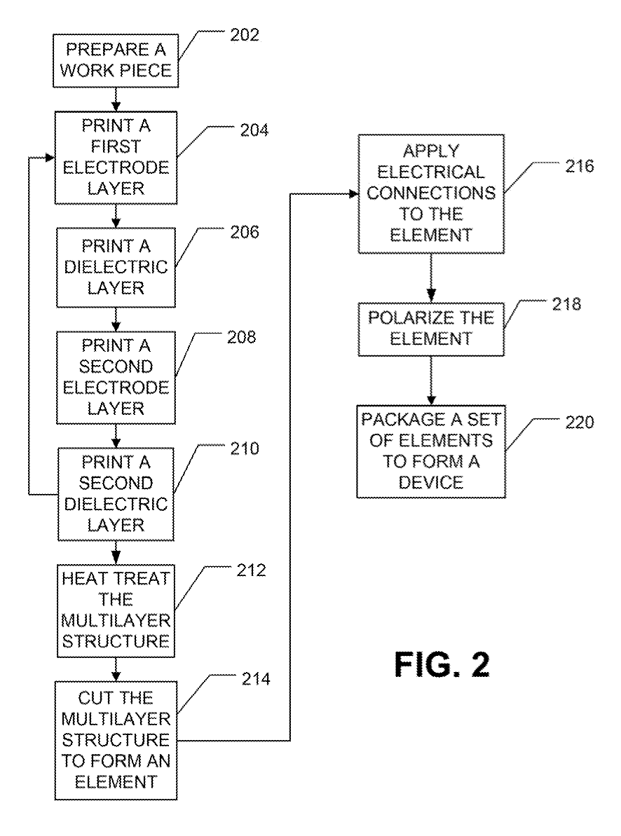

In a particular embodiment, a continuous flow device can be used in conjunction with embodiments of inks and suspensions describe below to form multilayer capacitors. For example, FIG. 2 includes a flow diagram illustrating an exemplary method of forming a capacitive element. As illustrated at 202, a work piece can be placed on a work piece support. To initiate the formation of the multilayer capacitor, the work piece can include a polymer film or a paper. Alternatively, the work piece support can be coated with polytetrafluoroethylene (PTFE) plastic, and a first layer of a polymer, such as poly(ethylene terephthalate) (PET), can be printed directly upon the work piece support. For example, a layer can be printed with an ink or suspension including solvents or polymeric binders in the amounts described below, absent electrically conductive or dielectric ceramic materials.

As illustrated at 204, a first electrode layer can be printed upon the work piece. The first electrode layer can be an anode layer or a cathode layer. In particular, the first electrode layer can be printed with an ink or suspension including an electrically conductive particulate such as aluminum, copper, nickel, tin or a combination of these electrically conductive particulate. For example, the ink or suspension can include one or more solvents, a burn-out binder, and an electrically conductive particulate. As the ink or suspension is deposited, the composition can form a conductive layer that can act as an electrode. In an example, the first electrode layer can have a thickness of between about 1 μm to about 11 μm. In particular, the ink or suspension is delivered in one or more continuous streams that are concurrently solidified.

Optionally, an insulative layer formed from an ink or suspension including solvents and burn-out organic binder with a dielectric polymeric particulate can be printed to surround the first electrode layer on at least three sides within the plane of the electrode layer. Alternatively, an insulative layer formed from an ink or suspension including solvents and burn-out polymeric binder with a dielectric glass particulate can be printed to surround the first electrode layer within the plane of the electrode layer. In a particular embodiment, the material of the electrode layer can be printed concurrently with at least a portion of the material of the insulative layer. Concurrently is used herein to indicate that events can occur simultaneously, can overlap in time, or one event can begin when another event is ending.

As illustrated at 206, a first dielectric layer can be printed over the first electrode layer. The first dielectric layer can be printed with an ink or suspension including a dielectric particulate. For example, the ink or suspension can include solvents, a burn-out binder (e.g., a cellulose-based binder), and a dielectric particulate material, which when deposited forms a dielectric material layer. The dielectric particulate material can include dielectric ceramic material. In an example, the first dielectric layer can have a thickness of between about 1 μm to about 11 μm. In particular, one or more continuous streams of the dielectric ink can be printed and concurrently solidified to from the dielectric material layer. Optionally, an insulative layer formed from an ink or suspension including solvents and burn-out organic binder, absent particulate filler, but having a dielectric polymeric particulate, can be printed to surround the first dielectric layer on four sides within the plane of the dielectric layer. In an example, the dielectric material layer can be printed concurrently with at least a portion of the insulative layer.

As illustrated at 208, a second electrode layer can be printed upon the first dielectric layer. As with the first electrode layer, the second electrode layer can be printed with an ink or suspension including an electrically conductive particulate. For example, the second electrode layer can be formed from an ink or suspension similar to that used to form the first electrode layer or can be formed from a different ink or suspension. Depending on the first electrode layer, the second electrode layer can be a cathode layer or an anode layer. For example, when the first electrode layer is an anode layer, the second electrode layer can be a cathode layer. The second electrode layer can have a thickness of between about 1 μm to about 11 μm. In a particular embodiment, the second electrode layer can be offset relative to the first electrode layer to permit separate electrical connection, such as separate electrical connection on opposite sides of the capacitive element. Optionally, an insulative layer formed from an ink or suspension including solvents and polymeric binder, absent ceramic filler, but having a dielectric polymeric particulate, can be printed to surround the second electrode layer on at least three sides within the plane of the electrode layer. In an example, the electrode layer can be printed concurrently with at least a portion of the insulative layer.

Further, as illustrated at 210, a second dielectric layer can be printed upon the second electrode layer. The second dielectric layer can be printed with an ink or suspension including a dielectric particulate. The second dielectric layer can be formed from an ink or suspension similar to that used to form the first dielectric layer or can be formed from a different ink or suspension. In an example the second dielectric layer can have a thickness of between about 1 μm to about 11 μm. Optionally, an insulative layer formed from an ink or suspension including solvents and polymeric binder, absent particulate filler, but having a dielectric polymeric particulate, can be printed to surround the second dielectric layer on four sides within the plane of the dielectric layer. In an example, the second dielectric layer and at least a portion of the insulative layer can be printed concurrently.

To form a multilayer capacitive element, the layering process can be repeated. Returning to 204, an additional electrode layer can be printed over the second dielectric layer. In an embodiment, the process can be repeated until at least about 500 layers are printed, and preferably at least about 1000 layers are printed, such as at least about 2000 layers.

In an exemplary embodiment, the layers are printed with a stream printer. As the ink is deposited, it can be heated by an energy source, such as an infrared energy source. Heating the ink as it approaches a work piece can evaporate a portion of the solvent, increasing the viscosity of the ink before it contacts the work piece. The increased viscosity can reduce the spread of the ink and variations in the thickness of the layer. Additionally, the energy source can remove portions of binder from the layer by thermal decomposition. Further, the energy source can sinter other portions of the binder. In an embodiment, the energy source can provide sufficient energy to sinter the layer, increasing the density of the layer at least about 75%, preferably at least about 85%, such as at least about 95%. In particular, the heat generated by the energy source is not sufficient to degrade the permanent polymer binder or the dielectric polymer particulate.

Alternatively, a gas, such as a hot gas can be directed over the deposited layers to evaporate solvent and decompose burn-out binders. For example, the gas can be clean dry air, nitrogen, or a noble gas. The gas can be heat to a temperature of 50° C. to 150° C.

In addition to or alternatively, the capacitive element can be heat treated or further heat treated after a plurality of layers, such as after substantially all the layers, are printed, as illustrated at 212. In particular, the capacitive element can be hot isostatically pressed, such as at a pressure of at least 80 bar, for example, between 80 bar and 120 bar. The temperature can be at least about 150° C., preferably at least about 165° C., such as between about 165° C. and about 215° C., or between about 170° C. and about 200° C. Alternatively, when the dielectric material includes a vitreous coating or when a vitreous glass insulation material is used, the temperature can be at least about 400° C., such as at least about 500° C., at least about 700° C. or even, at least about 900° C.

Further, the capacitive element can be cut, as illustrated at 214, and electrical connections applied to the electrodes, as illustrated at 216. For example, when the cathodes are offset from the anodes, as described above in relation to the first and second electrode layers, a single connection can be applied to a first side of the capacitive element to connect the cathodes, and a single connection can be applied to a second side of the capacitive element to connect the anodes. For example, the first and second sides can be dipped in a bath of molten metal. Alternatively, electrical connections can be established with a conductive adhesive.

Optionally, the multilayer capacitive element can be polarized, as illustrated at 218. For example, the capacitive element can be heated to a temperature of at least about 150° C., preferably at least about 165° C., such as between about 165° C. and about 215° C., or between about 170° C. and about 200° C. In addition, a voltage difference of at least 2000 V, such as at least 3000 V, or even at least 3750 V is applied between the anodes and cathodes after heating.

Further, the multilayer capacitive elements can be packaged into a capacitive storage device, as illustrated at 220. For example, more than one capacitive element can be electrically coupled and secured in a single physical arrangement to form a capacitive storage device. In particular, several capacitive elements can be placed in a housing that includes electrical contacts that couple the capacitive elements in parallel or serial arrangements, or combinations thereof, to form the capacitive storage device.

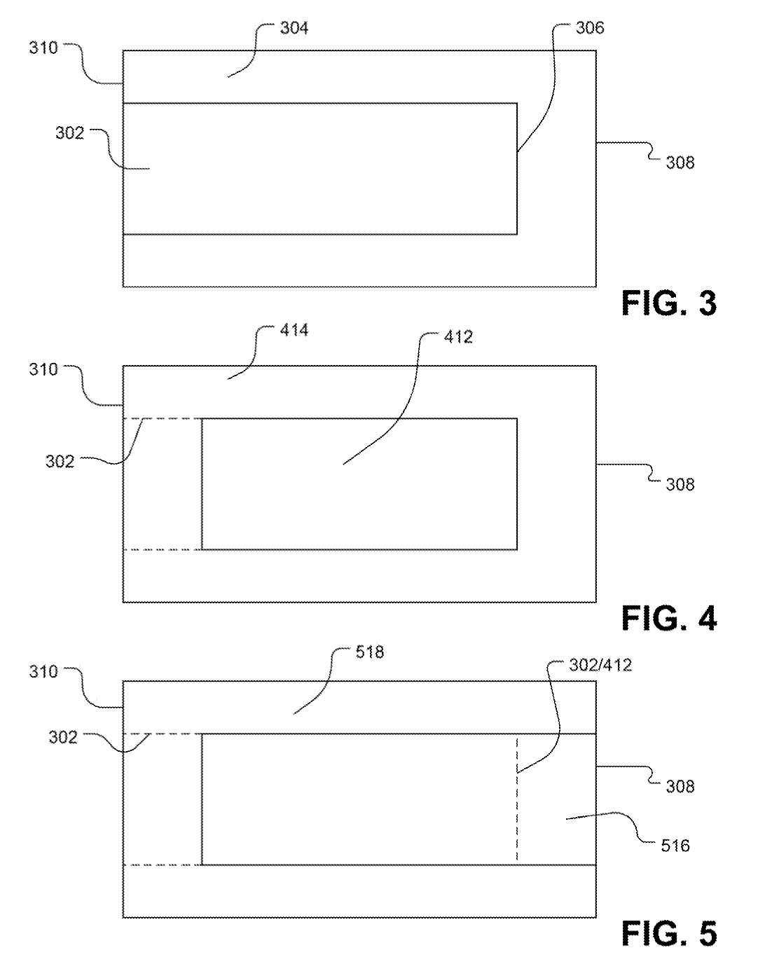

In an exemplary embodiment, the above method and printing device can be used to form patterned layers of elements of a capacitive storage device. Patterned layers describe the nature of each layer including within the layer a pattern of deposited materials. Patterned layers are deposited on top of one another to form capacitive elements of the capacitive storage device. For example, FIG. 3, FIG. 4, and FIG. 5 include illustrations of adjacent layers of a multilayer energy storage device. As used herein, longitudinal refers to the longest orthogonal dimension of a layer, transverse refers to the second longest orthogonal dimension and thickness refers to the third longest orthogonal dimension. For example, FIG. 3 includes an illustration of an exemplary electrode layer (e.g., an anode layer), FIG. 4 includes an illustration of an exemplary dielectric layer, and FIG. 5 includes an illustration of an exemplary opposite electrode layer (e.g., a cathode layer). As illustrated at FIG. 3, within the electrode layer, an electrode 302 is surrounded by an insulative portion 304, such as a dielectric polymeric portion. Alternatively, the dielectric polymeric portion 304 can be substituted with a vitreous glass portion. In particular, the electrode 302 extends from a first end 310 of the electrode layer to a position 306 that is spaced apart from the second end 308 of the electrode layer. As illustrated, the electrode 302 forms a rectangular shape that is surrounded on three sides by the insulative portion 304. Such an electrode layer can be formed using variations on the nozzle arrays described below.

As illustrated at FIG. 4, a dielectric layer includes a dielectric ceramic portion 412 surrounded by an insulative portion 414, such as a dielectric polymer portion, on four sides. The dielectric ceramic portion 414 can be disposed over a portion of the underlying electrode 302. Further, the dielectric ceramic portion 412 is spaced away from the edges 308 and 310 of the layers. Alternatively, the dielectric polymer portion 414 can be replaced with a vitreous glass portion. As above, such a dielectric ceramic layer and the associated dielectric ceramic portion 412 and insulative portion 414 can be printed using variations on the nozzle arrays described below.

As further illustrated in FIG. 5, a second electrode 516 can be printed within a layer and can be surrounded on three sides by an insulative portion 518, such as a dielectric polymer portion. The second electrode 516 can contact the edge 308 and can be spaced from the edge 310 in contrast to the first electrode 302. As such, the second electrode 516 is offset from the first electrode 302. Alternatively, the dielectric polymer portion 518 can be replaced with vitreous glass portion. Here too, the second electrode 516 and the dielectric polymer portion 516 can be formed using variations of the nozzle arrays described below.

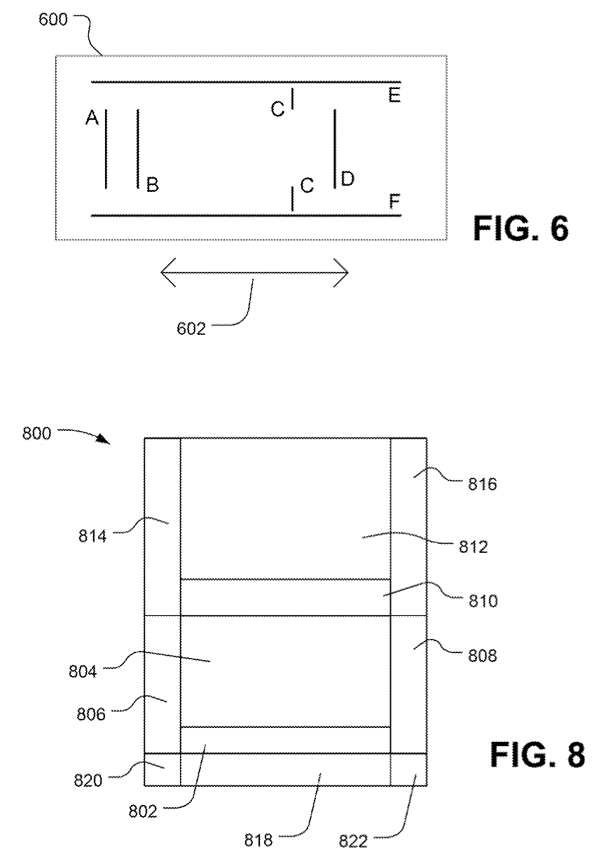

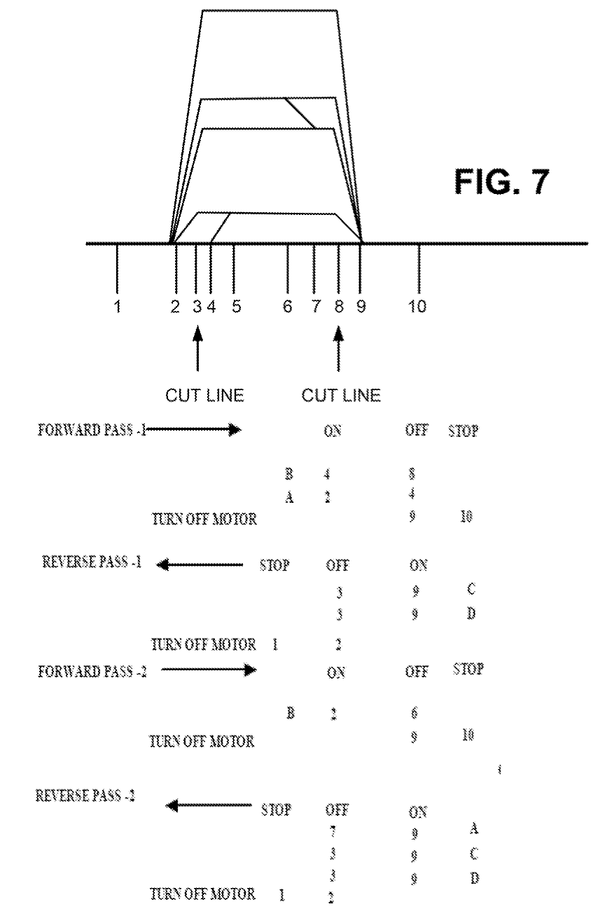

The multiple-layer capacitor configuration illustrated in FIG. 3, FIG. 4 and FIG. 5 can be utilized in the fabrication of capacitors for an energy-storage device. For example, the patterned layers can be printed using a single print head. Alternatively, more than one print head can be used. An exemplary print head is illustrated in FIG. 6. In particular, the patterned layers can be printed using continuous streams that are initiated and stopped based on position of the print head relative to the support. The layering in relation to the printing process, turn on and turn off timing of the valves, motor stopping signals is illustrated in FIG. 7. An exemplary cross-sectional view of the resulting layers is illustrated in FIG. 8. Capacitive devices can be formed by placing conductive end caps, such as copper end caps on the capacitive elements once cut along the cut lines indicated in FIG. 7.

FIG. 6 includes an illustration of an exemplary nozzle configuration 600. The nozzle configuration 600 is configured to print layers of the capacitive elements as the print head moves back and forth in the direction indicated at 602. The longitudinal direction is parallel to the direction 602 and transverse refers to the second longest orthogonal dimension within a plane parallel the print head. For example, nozzle A can be configured to dispense an ink to form a polymeric layer. Nozzle B can be configured to dispense an ink to form a conductive layer. Nozzle C can be configured to dispense ink to form a polymeric layer and Nozzle D can be configured to dispense an ink for forming a dielectric layer. Nozzles E and F can dispense clean dry gas such as air, nitrogen, or a noble gas.

In an example, nozzle A has a slit width in a range of 1.4 mils to 4 mils. Nozzle C has a slit width in a range of 4 mils to 8 mils, and nozzle D has a slit width in a range of 4 mils to 8 mils. Nozzle B can have a slit width in a range of 1.4 mils to 4 mils. The speed of the print head is in a range of 10 to 20 inches per second.

In particular, nozzle A and nozzles C are configured to dispense an ink that forms a polymeric layer. For example, nozzle A can dispense an ink to form polymeric layers at the planer ends of an electrode. In particular, nozzle A can be configured to dispense ink sufficient to form a polymeric end cap of equal thickness to the conductive layer forming the electrode. For example, the nozzle A can be configured to dispense sufficient ink to form a polymeric layer of thickness in a range of 0.5 microns to 3 microns, such as 0.5 microns to 2 microns, or 0.5 microns to 1.5 microns, or approximately 1 micron. While the nozzles C are configured to dispense a similar ink, the nozzle C can dispense enough ink sufficient to form a polymeric layer having a thickness of both a dielectric layer and a conductive layer. For example, if the dielectric layer is 10 microns and the conductive layer is 1 micron, the nozzle C can dispense sufficient ink to form an 11 micron polymeric layer. In particular, the nozzle C can be configured to dispense ink to form a layer in a range of 9 to 15 microns, such as a range of 9 to 12 microns, or even a range of 10 to 12 microns.

In a particular example, nozzles A and C are configured for the layering a resin powder, for example, poly(ethylene terephthalate) plastic (PET), within a binder solution which includes either a mixture of polypropylene carbonate (binder), and acetone (solvent) or solvents such as hexafluoro-2-propanol or 60/40 phenol/tetrachloroethylene. The concentration levels of the materials in the case of PET with either of the solvents can be varied to establish the appropriate viscosity for the layering or printing process.

Nozzle B is configured to dispense an ink to form a conductive layer useful as an electrode of the capacitive elements. For example, the operation of nozzle B can be configured to dispense ink to form conductive layers of thickness in a range of 0.5 microns to 3 microns, such as 0.5 microns to 2 microns, or even 0.5 microns to 1.5 microns, such as approximately 1 micron.

In particular, nozzle B can be used for the layering of an electrical-conducting-particulate containing ink. The ink may or may not include a binder solution of poly(propylene) carbonate. In another example, acetone can be used in both cases. The viscosity of this ink can be established by varying the concentrations of the constituents.

Nozzle D can be configured to dispense ink to form a dielectric layer. In an example, the nozzles D can be configured to dispense ink sufficient to form a dielectric layer having a thickness in a range of 8 to 15 microns, such as a range of 9 to 12 microns, or even a range of 9 to 11 microns, such as approximately 10 microns.

In a particular example, for the layering of the ceramic powder, for example, composition-modified barium titanate powder in a matrix of poly(ethylene terephthalate), the constituents are mixed with either a binder solution of poly(propylene) carbonate and acetone or solvents such as hexafluoro-2-propanol or 60/40 phenol/tetrachloroethylene, and are layered using the nozzle D. The concentration levels of the four materials or two materials in the case of PET with either of the solvents can be varied to establish the appropriate viscosity for the layering or printing process.

In particular, the nozzles can be controlled to dispense at particular times and at particular positions in conjunction with movement of the print head. When the print head is moving, the relative initiation of ink dispensing can result in the formation of layers of desired thickness and composition. For example as illustrated in FIG. 7, the nozzles can be turned on and off as the print head moves between position 1 and position 10 to print a series or set of layers of a conductive or capacitive device, for example, illustrated in FIG. 8.

Starting at position 1 illustrated at FIG. 7, the nozzle A can be turned on at position 2 and turned off at position 4 and nozzle B can be turned on at position 4 and turned off at position 8. The motor controlling the print head can be turned off at position 9 and the print head stopped at position 10. As a result, a first electrode layer 802 is formed. A reverse pass can be utilized to form the dielectric layer 804 and polymer layers 806 and 808. For example, going in reverse starting at position 10, nozzles C and D can be turned on at position 9 and off at position 3 and the motor controlling the print head turned off at position 2 and the print head stopped at position 1.

A subsequent electrode layer 810 can be deposited over the dielectric layer 804 utilizing a further forward pass starting at position 1. The nozzle B can be initiated at position 2 and turned off at position 6 and the motor can be turned off at position 9 and the print head stopped at position 10. Such a pass forms the conductive portion of an electrode layer 810 offset from the electrode layer 802.

An additional dielectric layer 812, a portion of the conductive layer 810, and polymeric layers 814 and 816 can be formed in a reverse pass starting at position 10. For example, nozzle A can be turned on at position 9 and turned off at position 7 forming a polymeric portion of the electric layer 810. The nozzles C and D can be turned on at position 9 and off at position 3 forming a dielectric layer 812 and sides of polymer layers 814 and 816. In an example, the driver of the print head is turned off at position 2 and the print head is stopped at position 1.

Prior to forming the structure illustrated in FIG. 8, full layers of polymeric material (e.g., 818, 820, and 822) can be formed using nozzles A and C. For example, nozzle A can be used to dispense multiple passes of a polymeric layer adding to an equivalent thickness as the layers dispense by nozzle C. Alternatively, the control rate flowing through nozzles A and C can be manipulated so that nozzles A and C dispense a polymer layer having uniform thickness.

The process of forming the interlaced dielectric and conductive layers can be repeated many times to form a capacitive element useful in capacitive energy storage devices. For example, the process can be repeated at least 100 times, such as at least 500 times, at least 800 times, or even at least 1000 times. While not illustrated in FIG. 7, a roller can traverse behind or in front of the print head to reduce voids within the layers. In an example, the roller is applied over the structure after deposition of each layer. Alternatively, the roller can be applied after deposition of more than one layer, such as every four layers.

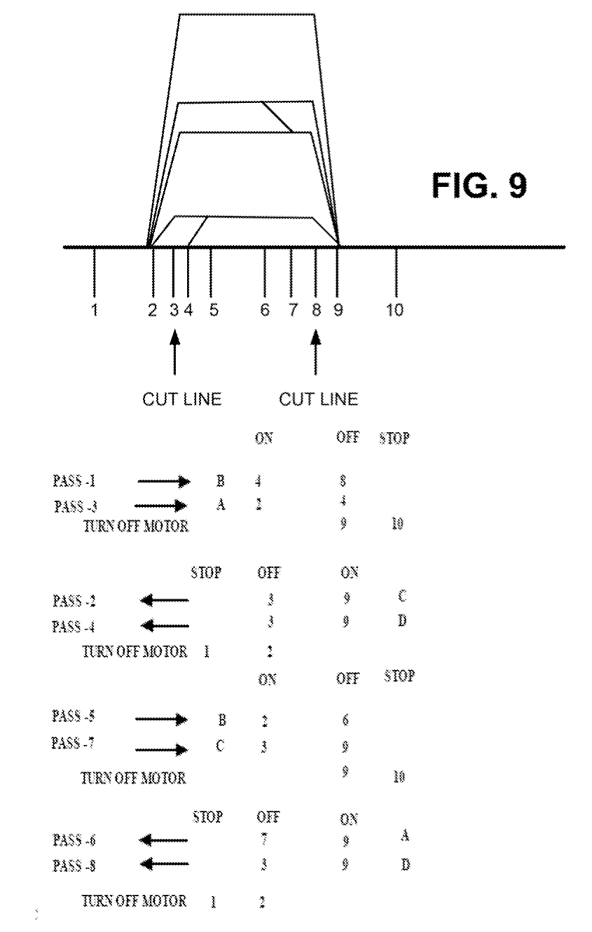

While FIG. 7 illustrates a four pass method of depositing layers, alternative methods including more or fewer steps can be envisaged. For example, as illustrated in FIG. 9, a first pass can include turning nozzle B on at position 4 and off at position 8. With each forward pass, the print head is stopped at position 10. In a second pass, in a direction opposite the first pass, a nozzle C can be turned on at position 9 and off at position 3. With each reverse pass, the print head is stopped at position 1. In a third pass, the nozzle A is turned on at position 2 and off at position 4. In a fourth pass, the nozzle D is turned on at position 9 and off at position 3. In a fifth pass, the nozzle B is turned on at position 2 and off a position 6. In a sixth pass, the nozzle A is turned on at position 9 and off at position 7. In a seventh pass, the nozzle C is turned on at position 3 and off at position 9. In an eighth pass, the nozzle D is turned on at position 9 and off at position 3. The process can be repeated to form additional capacitive elements. In addition, layers of polymer material can be printed before or after printing of the capacitive elements.

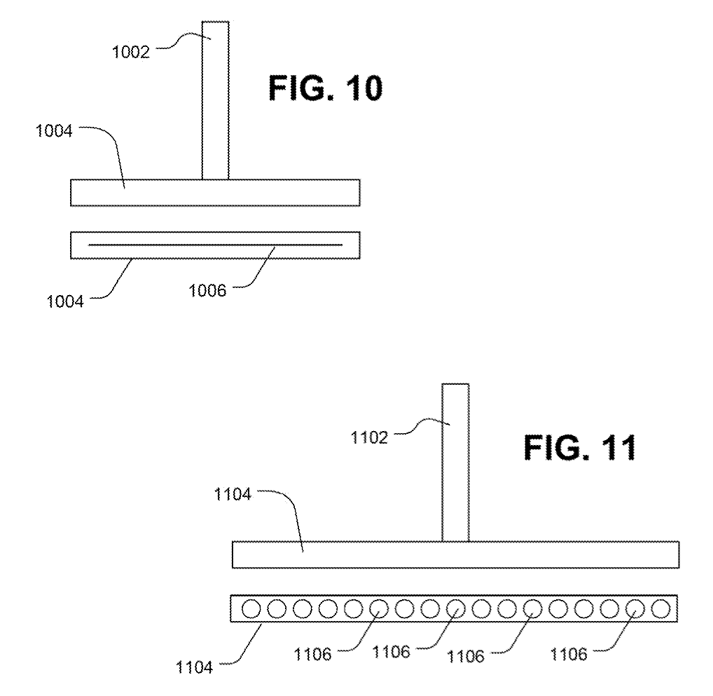

In a particular example, FIG. 10 includes an illustration of an exemplary nozzle useful for dispensing inks to form polymeric layers, conductive layers, and dielectric layers. For example, the nozzle 1000 includes a solution inlet tubing 1002 and a horizontal manifold 1004. A slit can be formed 1006 to dispense films forming the layers. Both ends of the manifold can be capped, resulting in ink being dispensed from the slit 1006.

To dispense gas useful in evaporating the solvent, nozzles E and F illustrated in FIG. 6 can utilize a gas nozzle as illustrated in FIG. 11. For example, the gas nozzle 1100 includes a gas inlet tube 1102 feeding a manifold 1104. The end caps of the manifold 1104 can be closed. On a bottom surface of the manifold 1104, a plurality of outlet holes 1108 can be provided. In an example, the outlet holes have a diameter in a range of 1/64″ to ⅛″. In a particular example, in the clean dry gas dispensed from the nozzle 1100 has a temperature in a range of 50° C. to 150° C.

Each of the inks includes a solvent and optionally a binder. In an exemplary embodiment, the solvent can be a polar organic solvent, including, for example, an alcohol such as propyl alcohol or isopropyl alcohol; a ketone such as methyl ethyl ketone or acetone; a glycol such as ethylene glycol, 1,2-propylene glycol, 1,3-propylene glycol, or diethylene glycol; a glycol ether such as diethylene glycol monoether, ethylene glycol butyl ether, diethylene glycol monobutyl ether, dipropylene glycol monomethyl ether, or ethylene glycol monoethyl ether; glycerol (glycerine or 1,2,3-propanetriol); an ester; an aldehyde; or any combination thereof. Alternatively, the solvent can be a nonpolar organic solvent including, for example, aliphatic hydrocarbons, such as hexane or mixed alkanes, or aromatic hydrocarbons, such as benzene or toluene.

In a further exemplary embodiment, the ink can include more than one solvent. For example, the ink can include a first solvent and a second solvent. The first solvent can be a solvent having a boiling point in a first range of temperatures, and the second solvent can be a solvent having a boiling point in a second range of temperatures, such as a range of temperatures higher than the first range of temperatures. As a result, the rate of evaporation of the first solvent can be higher than the rate of evaporation of the second solvent at a given temperature. Accordingly, the viscosity of the ink can change as the first solvent is evaporated, while providing a desirable rheology. In particular, the difference between the evaporation temperature of the first solvent and that of the second solvent can be at least about 10° C., such as at least about 25° C., at least about 50° C., or even at least about 75° C. In a particular embodiment, the first solvent can have a boiling point of not greater than about 140° C., and the second solvent can have a boiling point of at least about 170° C.

In an example, the binder can be configured to burn-out after deposition. An exemplary binder includes a cellulose-based binder. An example of a cellulose-based binder includes methyl cellulose ether, ethylpropyl cellulose ether, hydroxypropyl cellulose ether, cellulose acetate butyrate, nitrocellulose, or any combination thereof.

In an example, the polymeric material has a particle size of not greater than 10 microns. For example, the particle size of the polymer can be not greater than 5 microns, such as not greater than 2 microns, not greater than 1 micron, or even not greater than 0.5 microns. In particular, the particle size is not greater than 3 microns, such as not greater than 2 microns. In an example, the particle size can be greater than 0.01 microns.

In addition, the inks forming a polymer layer and those forming a dielectric layer can include a polarizable polymer. An exemplary polymer includes a polyester, such as polyethylene terephthalate (PET). Alternatively, another polymer can be substituted for PET in each of the proposed inks including PET. For example, other polyesters can be used. In particular, a polymeric material having sufficient voltage breakdown and being polar can be used. Other polymer substitutes are listed in Table 1, which provides information on the dielectric voltage breakdown strengths.

Other polymers include polyethylene, such as polyethylene (PE), low density polyethylene (LDPE), high density polyethylene (HDPE), linear low density polyethylene (LLDPE), crosslinked polyethylene (XLPE), or ultra high molecular weight polyethylene (UHMWPE); other polyolefins, such as polypropylene (PP), biaxially-oriented polypropylene, polybutylene (PB), or polyisobutene (PIB); polyacrylates, such as polymethyl methacrylate (PMMA), polymethyl acrylate (PMA), hydroxyethyl methacrylate (HEMA), or sodium polyacrylate; polystyrene, such as polystyrene (PS), high impact polystyrene (HIPS), extruded polystyrene (XPS), or expanded polystyrene; polyester, such as polyethylene terephthalate (PET); polysulfone, such as polysulfone (PSU), polyarylsulfone (PAS), polyethersulfone PES, or polyphenylsulfone (PPS); polyamide, such as polyamide (PA), polyphthalamide (PPA), bismaleimide (BMI), or urea formaldehyde (UF); polyurethane, such as polyurethane (PU), or polyisocyanurate (PIR); chloropolymer, such as polyvinyl chloride (PVC), or polyvinylidene dichloride (PVDC); (chloro)fluoropolymer; fluoropolymer, such as polytetrafluoroethylene (PTFE), polyvinylidene difluoride (PVDF), polychlorotrifluoroethlyene (PCTFE), or ethylene chlorotrifluoroethlyene (ECTFE); other homopolymer, such as polycarbonate (PC), polylactic acid (PLA), polyacrylamide (PAM), or polyetheretherketone (PEEK); other copolymer, such as acrylonitrile butadiene styrene (ABS), or polybutadiene acrylonitrile (PBAN); or any combination thereof

TABLE 1
Breakdown strength data for different polymer films.

| | Edb* | Edb** | | | | tanδ | |
|---|---|---|---|---|---|---|---|
| Material | (1 cm²) | (4 m²) | β-calc.** | β-mean*** | ε | #50 Hz | Electrodes + |
| PP, 14 μm | 680 | 570 | 62.3 | 24 | 2.2 | <0.0002 | 5 |
| PET, 15 μm | 695 | 537 | 41.1 | 27.0 | 3.3 | 0.0018 | 5 |
| PET, 15 μm | 675 | 421 | 22.5 | 22.7 | 3.3 | | 3 |
| PET, 8 μm, lot 1 | 652 | 427 | 25.1 | 25.1 | 3.3 | | 3 |
| PET, 8 μm, lot 2 | 558 | 347 | 22.2 | 27.6 | 3.3 | | 3 |
| PEN, 8 μm | 462 | 260 | 18.5 | 19.5 | 3.1 | | 3 |
| PEN, 12 μm | 463 | 357 | 40.7 | 32.2 | 3.1 | | 3 |
| PEN, 25 μm | 528 | 296 | 18.3 | 17.5 | 3.1 | 0.0037 | 5 |
| PC, 10 μm | 722 | 398 | 17.8 | 17.7 | 2.9 | 0.0009 | 5 |
| PSU, 25 μm | 446 | 171 | 11.1 | 12.4 | 3.1 | | 3 |
| PEI, 25 μm | 370 | 231 | 22.6 | 16.4 | 3.2 | | 2 |
| PEI, 25 μm | 415 | 239 | 19.2 | 19.3 | 3.2 | | 3 |
| PI, 8 och 12 μm | 470 | 300 | 25.1 | 51.5 | 3.4 | | 2 |
| PE 20 μm | 331 | 74 | 7 | 6.4 | | | 3 |

*EBD (1 cm²) refers to the interpolated breakdown strength for a 1 cm² samples size. The results presented in Table 1 are based on measurements performed with five electrodes of 0.045-9.3 cm² in size. In some cases, only three electrode areas were used in the analysis. The experimental details are explained later in the thesis.
**EBD (4 m²) refers to area extrapolated breakdown strength value and b-calc. for the slope of the extrapolation line. The extrapolation methods are discussed later in the thesis.
***β-mean is the average of the obtained β-values in the small electrode area measurement.
#The columns tan(δ) 50 Hz refers to the measured loss values.

The inks forming dielectric layers include a dielectric ceramic. An exemplary dielectric ceramic includes a high-permittivity ceramic powder, such as a high-permittivity composition-modified barium titanate powder, that can be used to fabricate high-quality dielectric devices. In an example, the particulate can include a doped barium-calcium-zirconium-titanate of the composition (Ba_{1-α-μ-v}A_{μ}DᵥCa_{α})[Ti_{1-x-δ-μ′-v′}Mn_{δ}A′_{μ′}D′_{v′}Zrₓ]_{z}O₃, where A=Ag or Zn, A′=Dy, Er, Ho, Y, Yb, or Ga; D=Nd, Pr, Sm, or Gd; D′=Nb or Mo, 0.10≦x≦0.25; 0≦μ≦0.01, 0≦μ′≦0.01, 0≦v≦0.01, 0≦v′≦0.01, 0<δ≦0.01, and 0.995≦z≦1.005, 0≦α≦0.005. Such barium-calcium-zirconium-titanate compounds have a perovskite structure of the general composition ABO₃, where the rare earth metal ions Nd, Pr, Sm, or Gd (having a large ion radius) can be arranged at A-sites, and the rare earth metal ions Dy, Er, Ho, Yb, the Group IIIB ion Y, or the Group IIIA ion Ga (having a small ion radius) can be arranged at B-sites. The perovskite material can include acceptor ions Ag, Zn, Dy, Er, Ho, Y, or Yb or donor ions Nb, Mo, Nd, Pr, Sm, or Gd at lattice sites having a different local symmetry. Donors and acceptors can form donor-acceptor complexes within the lattice structure of the barium-calcium-zirconium-titanate. In particular, the ceramic powder includes a cubic perovskite composition-modified barium titanate that is paramagnetic in a temperature range, such as temperature range of −40° C. to 85° C. or a temperature range of −25° C. to 65° C. Further, the ceramic powder is free of or has low concentrations of strontium or iron ions. In particular, the ceramic powder has a high-permittivity, such as a relative permittivity (K) of at least 15000, such as at least 30000.

The ceramic particulate forming the dielectric material can have a particle size in a range of 0.6 microns to 2 microns, such as a range of 0.6 microns to 1.5 microns, or even a range of 0.7 microns to 1.2 microns.

Further, inks forming conductive layers for electrodes include conductive materials. An exemplary conductive material includes metals, metal alloys, or conductive particles, such as carbon black or graphite, or any combination thereof. An exemplary metal includes aluminum, copper, zinc, tin, nickel, beryllium, manganese, iron, titanium, or any combination thereof. For example, the metal includes aluminum, copper, zinc, tin, nickel, or a combination thereof.

The conductive powder can have a particle size of not greater than 10 microns, such as not greater than 5 microns, not greater than 2 microns, or even not greater than 1 micron. For example, the particle size of the conductive powder can be not greater than 0.5 microns, such as not greater than 0.3 microns, or even not greater than 0.2 microns. In an example, the conductive powder has a particle size of at least 0.01 microns.

An exemplary ink forming a polymeric layer can include solvent in an amount of 5% to 30% by weight. For example, the solvent can be included in an amount of 5% to 20% by weight or even an amount of 5% to 15% by weight. The ink can further include the polymeric powder in an amount of 40% to 70% by weight, such as an amount of 50% to 70% by weight, or even 60% to 70% by weight. Further, the ink can include a binder. If used, the binder can be used in an amount of 0% to 30% by weight, such as an amount of 10% to 30% by weight, 10% to 20% by weight, or even 10% to 15% by weight. While embodiments of the above ink can include additional components, in another example, embodiments of the above ink consists essentially of the above described components, such as consist of the above described components.

An ink useful in forming dielectric layers can include solvent in the amount of 5% to 30% by weight. For example, the solvent can be included in an amount of 5% to 20% by weight, such as 5% to 15% by weight. The ink can further include a polymeric powder in an amount of 5% to 15% by weight. For example, the polymeric powder can be in an amount of 7% to 15% by weight, or even 10% to 15% by weight. Further, the ink includes a dielectric ceramic in an amount of 60% to 80% by weight. For example, the dielectric ceramic can be used in an amount of 65% to 80% by weight, or even 70% to 80% by weight. If used, the ink can also include a binder in an amount of 0% to 30% by weight, such as 10% to 30% by weight, 10% to 20% by weight, or even 10% to 15% by weight. While embodiments of the above ink can include additional components, in another example, embodiments of the above ink consists essentially of the above described components, such as consist of the above described components

An ink forming a conductive layer can include solvent such as in an amount of 5% to 30% by weight. For example, the solvent can be included in an amount of 5% to 20% by weight, or even 5% to 15% by weight. The ink further includes a conductive powder in an amount of 40% to 80% by weight, such as 50% to 80% by weight, or even 60% to 80% by weight. If used, a binder can be used in an amount of 0% to 30% by weight, such as 5% to 20% by weight, or even 5% to 15% by weight. While embodiments of the above ink can include additional components, in another example, embodiments of the above ink consists essentially of the above described components, such as consist of the above described components

The above three inks can be preheated to assist in the evaporation of the solvent during the layering process. Curing (drying) of the layered ink constituents is completed by hot clean dry air being blown onto the ink during the layering process. Hot clean dry air delivery lines are indicated in FIG. 7. If additional layer curing is required an inline furnace can be used to complete the curing process.

The processing parameters that establish the layer thickness include the ink viscosity, nozzle slit thickness, nozzle speed, and reservoir pressure. The reservoir temperature and the hot clean dry air temperature and volume supplied by nozzles E and F set the curing time of the printed layer. Thinner layers and lower and higher resistivity can be achieved depending on the application and constituent mixing, nozzle speeds, nozzle slit widths, reservoir pressures and temperatures, and composition of the constituents.

Embodiments of the above described method, assembly, and inks can provide technical advantages when preparing capacitive elements. Compounds configured for use with screen-printing techniques, such as inks and suspensions, work poorly when used with alternative techniques such as ink jet printing or layer printing techniques. In general, the inks or suspensions have undesirable rheology when used in conjunction with these other layering techniques. In contrast, the present inks can be used in layer printing techniques to prepare the element of a capacitive energy storage device as described above.

In a first aspect, a printer includes a work surface and a print head disposed over the work surface. The print head and the work surface are relatively movable in associated parallel planes. The print head includes a first nozzle to deposit a polymeric ink, a second nozzle to deposit a conductive ink, and a third nozzle to deposit a dielectric ink.

In an example of the first aspect, the print head further includes a fourth nozzle to deposit the polymeric ink. The fourth nozzle can be positioned to deposit adjacent the third nozzle.

In another example of the first aspect, the first, second and third nozzles are aligned. In an additional example of the first aspect, the first, second and third nozzles can print over the same area.

In a further example of the first aspect, the first nozzle forms a first slit having a width of 1.4 mils to 4 mils. The second nozzle can form a second slit having a width of 1.4 mils to 4 mils. The third nozzle can form a third slit having a width of 4 mils to 8 mils.

In an example of the first aspect, the first, second and third nozzles dispense a continuous stream. The printer can further include first, second, and third valves associated with the first, second, and third nozzles, respectively, the first, second, and third valves to control dispensing from the first, second, and third nozzles, respectively.

In a second aspect, a method of forming a capacitive element includes depositing a conductive ink from a first nozzle of a print head in a first layer to form an electrode, depositing a polymeric ink from a second nozzle of the print head in the first layer at a longitudinal end of the electrode, depositing a dielectric ink from a third nozzle of the print head to form a dielectric component in a second layer over the electrode, and depositing a polymeric ink from a fourth nozzle of the print head in the second layer on a transverse side of the dielectric component.

In an example of the second aspect, the method further includes depositing the conductive ink from the first nozzle of the print head in a third layer to form a second electrode, the second electrode longitudinally offset from the electrode, and depositing the polymeric ink from the second nozzle of the print head in the third layer at a second longitudinal end of the second electrode opposite the longitudinal end of the electrode.

In another example of the second aspect, the method further includes depositing the dielectric ink from the third nozzle of the print head to form a second dielectric component in a fourth layer over the second electrode, and depositing the polymeric ink from the fourth nozzle of the print head in the fourth layer on the transverse side of the second dielectric component.

In a third aspect, an ink includes solvent in an amount of 5% to 30% by weight, and polymeric particulate in an amount of 40% to 70% by weight. In an example of the third aspect, the ink can further include binder in an amount of 10% to 20% by weight, such as 10% to 15% by weight. The binder can be a cellulose-based binder.

In another example of the third aspect, the amount of solvent is 5% to 20% by weight, such as 5% to 15% by weight. The solvent can be selected from the group consisting of an alcohol, a ketone, a glycol, a glycol ether, glycerol, an ester, an aldehyde, and any combination thereof. In another example, the solvent is selected from the group consisting of aliphatic hydrocarbons, aromatic hydrocarbons, or any combination thereof.

In an additional example of the third aspect, the amount of polymeric particulate is 50% to 70% by weight, such as 60% to 70%. The polymeric particulate can have a particle size of not greater than 2 microns. In an example of the third aspect, the polymeric particulate is selected from the group consisting of polyethylene, other polyolefins, polyacrylates, polystyrene, polyester, polysulfone, polyamide, polyurethane, chloropolymer, (chloro)fluoropolymer, fluoropolymer, polycarbonate (PC), polylactic acid (PLA), polyacrylamide (PAM), polyetheretherketone (PEEK), acrylonitrile butadiene styrene (ABS), polybutadiene acrylonitrile (PBAN), and any combination thereof.

In a fourth aspect, an ink includes solvent in an amount of 5% to 30% by weight, polymeric particulate in an amount of 5% to 15% by weight, and dielectric particulate in an amount of 60% to 80% by weight.

In an example of the fourth aspect, the ink further includes binder in an amount of 10% to 20% by weight. The binder can be a cellulose-based binder.

In another example of the fourth aspect, the amount of solvent is 5% to 20% by weight. The solvent can be selected from the group consisting of an alcohol, a ketone, a glycol, a glycol ether, glycerol, an ester, an aldehyde, and any combination thereof. In another example, the solvent is selected from the group consisting of aliphatic hydrocarbons, aromatic hydrocarbons, or any combination thereof.

In a further example of the fourth aspect, the amount of polymeric particulate is 7% to 15% by weight, such as 10% to 15%. The polymeric particulate can have a particle size of not greater than 2 microns. In an example of the fourth aspect, the polymeric particulate is selected from the group consisting of polyethylene, other polyolefins, polyacrylates, polystyrene, polyester, polysulfone, polyamide, polyurethane, chloropolymer, (chloro)fluoropolymer, fluoropolymer, polycarbonate (PC), polylactic acid (PLA), polyacrylamide (PAM), polyetheretherketone (PEEK), acrylonitrile butadiene styrene (ABS), polybutadiene acrylonitrile (PBAN), and any combination thereof.

In an additional example of the fourth aspect, the amount of dielectric particulate is 65% to 80% by weight, such as 70% to 80% by weight. The dielectric particulate can be a cubic perovskite material. In another example, the dielectric particulate is a composition-modified barium titanate.

In a fifth aspect, an ink includes solvent in an amount of 5% to 30% by weight and conductive particulate in an amount of 40% to 80% by weight.

In an example of the fifth aspect, the ink further includes binder in an amount of 10% to 20% by weight. The binder can be a cellulose-based binder.

In another example of the fifth aspect, the amount of solvent is 5% to 20% by weight. The solvent can be selected from the group consisting of an alcohol, a ketone, a glycol, a glycol ether, glycerol, an ester, an aldehyde, and any combination thereof. In a further example, the solvent is selected from the group consisting of aliphatic hydrocarbons, aromatic hydrocarbons, or any combination thereof.

In an additional example of the fifth aspect, the amount of conductive particulate is 50% to 80% by weight, such as 60% to 80%. The conductive particulate can have a particle size of not greater than 2 microns. In an example, the conductive particulate is selected from the group consisting of a metal, metal alloy, carbon black, graphite and any combination thereof. In a further example, the metal is selected from the group consisting of aluminum, copper, zinc, tin, nickel, beryllium, manganese, iron, titanium, and any combination thereof.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A printer comprising:
a work surface; and
a print head disposed over the work surface, the print head and the work surface relatively movable in associated parallel planes, the print head comprising a first nozzle to deposit a polymeric ink, a second nozzle to deposit a conductive ink, and a third nozzle to deposit a dielectric ink.

2. The printer of claim 1, wherein the print head further comprises a fourth nozzle to deposit the polymeric ink.

3. The printer of claim 2, wherein the fourth nozzle is positioned to deposit adjacent the third nozzle.

4. The printer of claim 1, wherein the first, second and third nozzles are aligned.

5. The printer of claim 1, wherein the first, second and third nozzles can print over the same area.

6. The printer of claim 1, wherein the first nozzle forms a first slit having a width of 1.4 mils to 4 mils.

7. The printer of claim 1, wherein the second nozzle forms a second slit having a width of 1.4 mils to 4 mils.

8. The printer of claim 1, wherein the third nozzle forms a third slit having a width of 4 mils to 8 mils.

9. The printer of claim 1, wherein the first, second and third nozzles dispense a continuous stream.

10. The printer of claim 1, further comprising first, second, and third valves associated with the first, second, and third nozzles, respectively, the first, second, and third valves to control dispensing from the first, second, and third nozzles, respectively.

11. A method of forming a capacitive element, the method comprising:
depositing a conductive ink from a first nozzle of a print head in a first layer to form an electrode;
depositing a polymeric ink from a second nozzle of the print head in the first layer at a longitudinal end of the electrode;
depositing a dielectric ink from a third nozzle of the print head to form a dielectric component in a second layer over the electrode; and
depositing a polymeric ink from a fourth nozzle of the print head in the second layer on a transverse side of the dielectric component.

12. The method of claim 11, further comprising:
depositing the conductive ink from the first nozzle of the print head in a third layer to form a second electrode, the second electrode longitudinally offset from the electrode; and
depositing the polymeric ink from the second nozzle of the print head in the third layer at a second longitudinal end of the second electrode opposite the longitudinal end of the electrode.

13. The method of claim 12, further comprising:
depositing the dielectric ink from the third nozzle of the print head to form a second dielectric component in a fourth layer over the second electrode; and
depositing the polymeric ink from the fourth nozzle of the print head in the fourth layer on the transverse side of the second dielectric component.

14.-25. (canceled)

26. An ink comprising:
solvent in an amount of 5% to 30% by weight;
polymeric particulate in an amount of 5% to 15% by weight; and
dielectric particulate in an amount of 60% to 80% by weight.

27.-29. (canceled)

30. The ink of claim 26, wherein the solvent is selected from the group consisting of an alcohol, a ketone, a glycol, a glycol ether, glycerol, an ester, an aldehyde, and any combination thereof.

31. The ink of claim 26, wherein the solvent is selected from the group consisting of aliphatic hydrocarbons, aromatic hydrocarbons, or any combination thereof.

32.-33. (canceled)

34. The ink of claim 26, wherein the polymeric particulate has a particle size of not greater than 2 microns.

35. The ink of claim 26, wherein the polymeric particulate is selected from the group consisting of polyethylene, other polyolefins, polyacrylates, polystyrene, polyester, polysulfone, polyamide, polyurethane, chloropolymer, (chloro)fluoropolymer, fluoropolymer, polycarbonate (PC), polylactic acid (PLA), polyacrylamide (PAM), polyetheretherketone (PEEK), acrylonitrile butadiene styrene (ABS), polybutadiene acrylonitrile (PBAN), and any combination thereof.

36.-37. (canceled)

38. The ink of claim 26, wherein the dielectric particulate is a cubic perovskite material.

39. The ink of claim 26, wherein the dielectric particulate is a composition-modified barium titanate.

40.-50. (canceled)
